(19) United States
(12) Patent Application Publication
(10) Pub. No.: US 2018/0061365 A1
(43) Pub. Date: Mar. 1, 2018

(54) DISPLAY APPARATUS AND METHOD OF EXECUTING CALIBRATION THEREIN

(71) Applicant: SAMSUNG ELECTRONICS CO., LTD., Suwon-si (KR)

(72) Inventors: Sang Eun LEE, Seoul (KR); Hyun Ho KIM, Seoul (KR)

(73) Assignee: SAMSUNG ELECTRONICS CO., LTD., Suwon-si (KR)

(21) Appl. No.: 15/687,177

(22) Filed: Aug. 25, 2017

(30) Foreign Application Priority Data
Aug. 30, 2016 (KR) 10-2016-0111121

(51) Int. Cl. G09G 5/00; H04N 5/05; G09G 3/00; G09G 3/20; H04N 17/04

(52) U.S. Cl. CPC G09G 5/008; H04N 5/05; G09G 3/006; G09G 2350/00; H04N 17/04; G09G 2370/12; G09G 3/2092

(57) ABSTRACT

A display apparatus includes a communication interface connected with a source device, a display that displays a video signal received from the source device, and a processor that establishes connection for receiving the video signal. The processor synchronizes a clock of the display apparatus with a clock of the source device such that the connection is established and executes calibration for the video signal, when detecting an error occurring as the clock of the display apparatus fails to be synchronized.

### CROSS-REFERENCE TO RELATED APPLICATION(S)

This application claims the benefit under 35 U.S.C. §119(a) of a Korean patent application filed on Aug. 30, 2016 in the Korean Intellectual Property Office and assigned Serial number 10-2016-0111121, the entire disclosure of which is hereby incorporated by reference.

### TECHNICAL FIELD

The present disclosure relates to a display apparatus, capable of executing calibration to receive a video signal, and a method of executing the calibration in the display apparatus.

### BACKGROUND

A high definition multimedia interface (HDMI), which is a kind of a digital communication scheme, is a standard for a video and audio interface between a multimedia source and a display apparatus. An HDMI connector requires a smaller number of cables and has a smaller size and thus a user may feel convenient in the use of the HDMI connector.

The HDMI may transmit high-definition digital video signals and audio signals in an uncompressed manner. Since the HDMI transmits uncompressed digital video and audio signals, a decoder chip or software is not required.

The HDMI transmits the video and audio signals in a transmission minimized differential signaling (TMDS) scheme. The multimedia source converts the video and audio signals into TMDS channel signals to be transmitted to the display apparatus through a TMDS channel.

When receiving content from the source device through an HDMI terminal, the display apparatus receives signals through the HDMI cables. When the HDMI cables are disconnected or the characteristics of the HDMI cables for transmitted signals are inferior, the display apparatus may not correctly receive the HDMI signals.

When the display apparatus does not receive the video signal, when it is difficult for a user to change settings of the display apparatus in relation to the reception of HDMI signals, the user has to cope with the situation only by replacing the HDMI cable with new one.

### SUMMARY

Aspects of the present disclosure are to address at least the above-mentioned problems and/or disadvantages and to provide at least the advantages described below. Accordingly, various embodiments of the present disclosure are to provide display apparatuses, capable of receiving HDMI signals by executing calibration even when the display apparatuses fail to receive the HDMI signals, and methods of executing the calibration in the display apparatuses.

According to an embodiment of the present disclosure, a display apparatus may include a communication interface connected with a source device, a display that displays a video signal received from the source device, and a processor that establishes connection for receiving the video signal. The processor may be configured to synchronize a clock of the display apparatus with a clock of the source device such that the connection is established and to execute calibration for the video signal, when detecting an error occurring as the clock of the display apparatus fails to be synchronized.

According to an embodiment of the present disclosure, a method of executing calibration in a display apparatus may include determining whether a clock of the display apparatus is synchronized with a clock of a source device, and executing calibration for a video signal when the clock of the display apparatus fails to be synchronized with the clock of the source device.

According to an embodiment of the present disclosure, a computer-readable recording medium may have a program to perform a method including determining whether a clock of the display apparatus is synchronized with a clock of a source device and executing calibration for a video signal when the clock of the display apparatus fails to be synchronized with the clock of the source device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a display system, according to various embodiments of the present disclosure;

FIG. 2 is a bock diagram illustrating the configuration of a display apparatus, according to various embodiments of the present disclosure;

FIG. 3 is a block diagram illustrating the configuration of a processor, according to various embodiments of the present disclosure;

FIG. 4 is a block diagram illustrating the configuration of an error diagnosing module, according to various embodiments of the present disclosure;

FIG. 5 is a block diagram illustrating the configuration of a calibration module, according to various embodiments of the present disclosure;

FIG. 6 illustrates a UI displayed on a display when the display apparatus fails to receive a video signal, according to various embodiments of the present disclosure;

FIG. 7 is a flowchart illustrating the logic of a method of determining a connection standby state, according to various embodiments of the present disclosure;

FIGS. 8A and 8B illustrate a UI displayed on the display to proceed with the calibration for a video signal, according to various embodiments of the present disclosure;

FIG. 9 is a flowchart illustrating the logic of a method of performing a calibration, according to various embodiments of the present disclosure;

FIG. 10A is a flowchart illustrating the logic of a method of adjusting a bandwidth value of a PLL circuit or an EQ value, according to an embodiment of the present disclosure;

FIG. 10B is a flowchart illustrating the logic of a method of sequentially adjusting a bandwidth value of a PLL circuit and an EQ value, according to an embodiment of the present disclosure; and

FIGS. 11 and 12 illustrate a UI displayed on a display after proceeding with calibration is performed, according to various embodiments of the present disclosure.

Throughout the drawings, it should be noted that like reference numbers are used to depict the same or similar elements, features, and structures.

### DETAILED DESCRIPTION

Hereinafter, various embodiments of the present disclosure will be described more fully with reference to accompanying drawings.

Embodiments of the present disclosure are provided to fully describe the scope of the present disclosure to those of ordinary skill in the art. Following embodiment of the present disclosure may, however, be embodied in many different forms and should not be construed as being limited to the embodiments set forth herein. Rather, these embodiments are provided so that this disclosure will be thorough and complete, and will fully convey the scope of the present disclosure to those of ordinary skill in the art.

Hereinafter, various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar elements may be marked by similar reference numerals.

In this disclosure, the expressions “have”, “may have”, “include” and “comprise”, or “may include” and “may comprise” used herein indicate existence of corresponding features (e.g., elements such as numeric values, functions, operations, or components) but do not exclude presence of additional features.

In this disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used in this disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in this disclosure are used to describe specified embodiments and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of this disclosure. In some cases, even when terms are terms which are defined in this disclosure, they may not be interpreted to exclude embodiments of this disclosure.

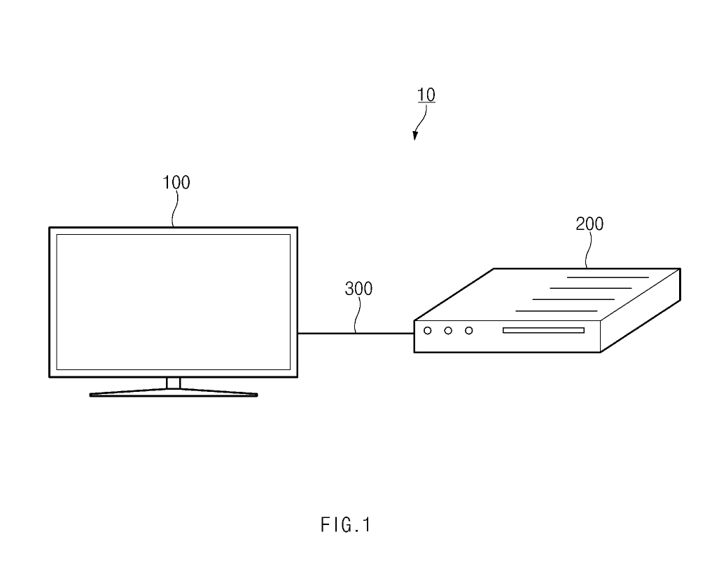

FIG. 1 is a view illustrating a display system, according to various embodiments of the present disclosure.

Referring to FIG. 1, a display system 10 may include a display apparatus 100, a source device 200, and a cable 300.

The display apparatus 100 may receive an image from an external device. For example, the display apparatus 100 may receive broadcast content from a broadcast station through a broadcast network or may receive web content from a web server through the Internet.

According to an embodiment, the display apparatus 100 may be connected with the source device 200 through wired digital communication for the reception of the content and thus may receive an image and a video including the image. For example, the wired digital communication may be wired communication based on a high definition multimedia interface (HDMI) scheme. For example, the image may include an image of a user interface (UI) created by the source device 200, as well as a content image. The content image may include, for example, images of a film, a drama, news, a game, or the like.

According to an embodiment, the display apparatus 100 may display the UI on a display thereof. For example, the display apparatus 100 may display the connection state with the source device 200 and an error diagnosis result on the display. Alternatively, the display apparatus 100 may display a message or a menu for receiving a command to be inputted by a user on the display.

According to an embodiment, the display apparatus 100 may be implemented with various devices which are able to receive and display content from an external device, such as a television (TV), a desktop computer, a laptop personal computer (PC), a smart phone, a tablet PC, a monitor, an electronic frame, or the like.

The source device 200 may transmit a content image, which is received from another device or stored in an internal (or external) recording medium, to the display apparatus 100. For example, the source device 200 may receive broadcast content from a broadcast station through a broadcast network or may receive web content from a web server through the Internet. The source device 200 may reproduce content stored in the recording medium and may transmit an image of the content to the display apparatus 100. The recording medium may include, for example, a compact disk (CD), a digital versatile disk (DVD), a hard disk, a Bluelay disk, a memory card, a universal serial bus (USB) memory, or the like.

According to an embodiment, the source device 200 may be implemented with various devices, such as a set-top box, a game console (e.g., Xbox™, PlayStation™, or the like), a smart phone, a tablet PC, and the like, to receive or store content and to transmit the content to the display apparatus 100.

The cable 300 may connect the display apparatus 100 with the source device 200. According to an embodiment, the cable 300 may be an HDMI cable. Connectors of the HDMI cable may be connected with HDMI interfaces of the display apparatus 100 and the source device 200, respectively. The display apparatus 100 connected with the HDMI cable may receive the input of an HDMI signal through an HDMI interface. The source device 200 may output the HDMI signal through the HDMI interface. The connector may have 19 pins including pins for transmitting transition minimized display signaling (TMDS) data, a clock, a 5V voltage, or the like. The size of the connector may be a mini size or a micro size according to devices connected with the connectors.

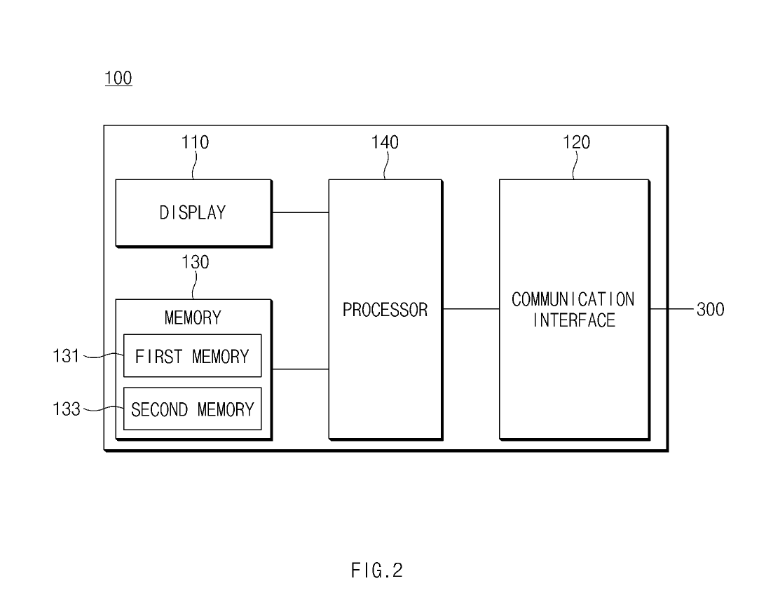

FIG. 2 is a block diagram illustrating the configuration of a display apparatus, according to various embodiments of the present disclosure.

Referring to FIG. 2, the display apparatus 100 may include a display 110, a communication interface 120, a memory 130, and a processor 140.

The display 110 may display an image received from the source device 200. For example, the display 110 may display the image received from the source device 200 at a specific frame rate.

The communication interface 120 may communicate with an external device. The communication interface 120 may include a wired communication interface and a wireless communication interface. According to an embodiment, the communication interface 120 may receive a video signal from the source device 200 as the wired communication interface is connected with the HDMI cable. The video signal may include images transmitted from the source device 200. According to an embodiment, the communication interface 120 may receive a control signal from a remote controller as the wireless communication interface is connected with the remote controller. For example, the control signal may be generated through the input by the user using the remote controller.

The memory 130 may store information necessary for the display apparatus 100 to receive the video signal from the source device 200.

According to an embodiment, the memory 130 may include a first memory 131 and a second memory 133. For example, the first memory 131 may include a non-volatile memory, such as a flash memory or a hard disk, and the second memory 132 may be a volatile memory such as a random access memory (RAM). According to another embodiment, the second memory 132 may be included in the processor 140.

According to an embodiment, the memory 130 may store extended display identification data (EDID) of the display apparatus 100. The EDID, which serves as data for authentication between devices, may be a standard for communication between the display apparatus 100 and the source device 200. The EDID may include information on the display apparatus 100. The information on the display apparatus 100 may include, for example, a manufacturer name, a product type, a phosphor type, a filter type, a screen size, brightness, a pixel, or the like. The EDID may be stored in the first memory 131. The EDID stored in the first memory 131 may be copied into and temporarily stored in the second memory 133 when the display apparatus 100 is booted (or initialized). The EDID stored in the second memory 133 may be transmitted to the source device 200 when the source device 200 is connected with the display apparatus 100. Accordingly, the source device 200 may output an image having a format suited to the display apparatus 100 by using the EDID.

According to an embodiment, the memory 130 may store authentication information of high-bandwidth digital content protection (HDCP) therein. The HDCP may be a copyright protection standard for illegal copy protection of content in a digital imaging device. The authentication information of the HDCP may include HDCP key data for the authentication of the HDCP. The authentication information of the HDCP may be stored in the first memory 131. The authentication information of the HDCP stored in the first memory 131 may be copied into and temporarily stored in the second memory 133 while the display apparatus 100 performs the authentication of the HDCP. The authentication information of the HDCP stored in the second memory 133 may be transmitted to the source device 200 when the display apparatus 100 performs the authentication of the HDCP. Accordingly, the display apparatus 100 may complete the authentication of the HDCP and may process the video signal received from the source device 200.

The processor 140 may control the overall operations of the display apparatus 100. For example, the processor 140 may receive and process the video signal by controlling each of the display 110, the communication interface 120, and the memory 130.

According to an embodiment, the display apparatus 100 may include at least one processor 140. For example, the display apparatus 100 may include a plurality of processors 140 which is able to perform at least one function. According to another embodiment, the processor 140 may be implemented in the form of a system on chip (SoC) including a central processing unit (CPU), a graphic processing unit (GPU), a memory, and the like. The second memory 133 may be, for example, included in the processor 140.

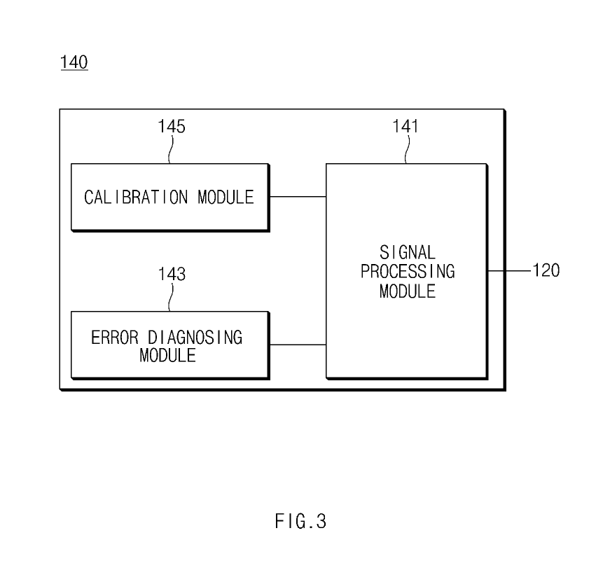

FIG. 3 is a block diagram illustrating the configuration of the processor, according to various embodiments of the present disclosure.

Referring to FIG. 3, the processor 140 may include a signal processing module 141, an error diagnosing module 143, and a calibration module 145. Each element of the processor 140 may be an individual hardware module or a software module implemented by at least one processor. For example, functions of modules included in the processor 140 may be performed by one processor or by individual processors, respectively.

The signal processing module 141 may receive the video signal by controlling the communication interface 120 and may process the video signal such that the video signal is displayed on the display 110.

According to an embodiment, the signal processing module 141 may transmit the EDID of the display apparatus 100 stored in the second memory 133 to the source device 200 when the source device 200 is first connected with the display apparatus 100. The source device 200 may transmit, for example, an image suited to the display apparatus 100 on the basis of the received EDID.

According to an embodiment, the signal processing module 141 may synchronize a clock of the display apparatus 100 with a clock of the source device 200 to process the received signal.

According to an embodiment, the signal processing module 141 may transmit the authentication information of the HDCP stored in the second memory 133 to the source device 200 for the authentication of the HDCP. For example, the display apparatus 100 may complete the authentication of the HDCP and may process the signal received from the source device 200.

According to an embodiment, the signal processing module 141 may include a phase locked loop (PLL) circuit and an equalizer (EQ) to receive the video signal. The signal processing module 141 may control reception sensitivity of the video signal by changing a bandwidth value of the PLL circuit and an EQ value. The signal processing module 141 may reduce a jitter phenomenon of the display apparatus 100 by adjusting the reception sensitivity of the video signal.

The error diagnosing module 143 may detect errors occurring when the connection is established between the display apparatus 100 and the source device 200. For example, the error diagnosing module 143 may detect errors which occur when the signal processing module 141 performs checking and authentication processes for the reception of the video signal. When detecting the errors of the signal processing module 141, the error diagnosing module 143 may transmit the detected errors to the calibration module 145.

The calibration module 145 may perform the calibration of the signal processing module 141. For example, the calibration module 145 may perform the calibration for the video signal by using information on errors transmitted from the error diagnosing module 143.

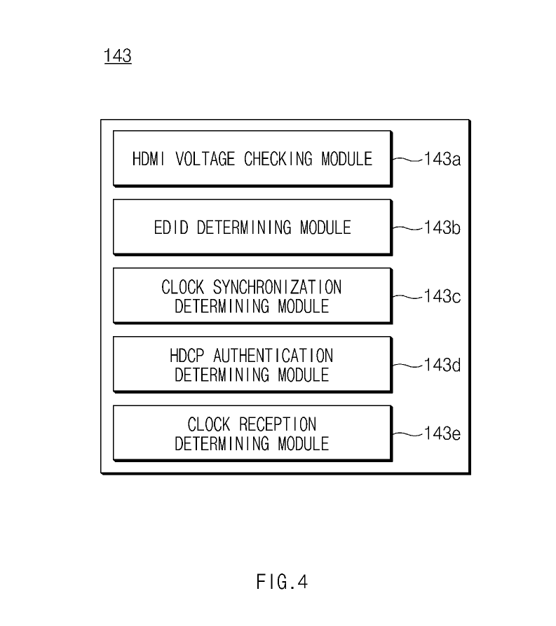

FIG. 4 is a block diagram illustrating the configuration of the error diagnosing module, according to various embodiments of the present disclosure.

Referring to FIG. 4, the error diagnosing module 143 may include an HDMI voltage checking module 143a, an EDID determining module 143b, a clock synchronization determining module 143c, an HDCP authentication determining module 143d, and a clock reception determining module 143e.

The HDMI voltage checking module 143a may check a connection state of the source device 200 by measuring a voltage that is inputted when the source device 200 is connected. When the source device 200 is connected with the display apparatus 100 through the HDMI interface of the display apparatus 100, a voltage having a specific size (e.g., 5V) may be pulled up to detect the connection of the source device 200. For example, the HDMI voltage checking module 143a may check the connection state of the source device 200 by measuring the voltage inputted through an HDMI port. Accordingly, the error diagnosing module 143 may detect a connection error of the source device 200 when the voltage having the specific size is not measured.

The EDID determining module 143b may determine whether the source device 200 receives EDID by determining whether the EDID of the display apparatus 100 is stored in the second memory 133. Therefore, the EDID determining module 143b may detect a reception error of the EDID when the EDID is not determined as being stored in the second memory 133.

The clock synchronization determining module 143c may determine whether a clock of the display apparatus 100 is synchronized with a clock of the source device 200. For example, the PLL circuit of the signal processing module 141 may detect the phase difference between the clock of the display apparatus 100 and the clock of the source device 200 and may lock the phase of the clock of the display apparatus 100 on the basis of the phase difference, thereby synchronizing the clock of the display apparatus 100 with the clock of the source device 200. According to an embodiment, the clock synchronization determining module 143c may determine whether the clock of the display apparatus 100 is synchronized with the clock of the source device 200 by determining whether the clock of the display apparatus 100 is locked. Accordingly, the error diagnosing module 143 may detect a clock synchronization error when the clock of the display apparatus 100 is not locked.

The HDCP authentication determining module 143d may determine whether the HDCP authentication is performed by the signal processing module 141. According to an embodiment, the HDCP authentication determining module 143d may include an HDCP authentication counting module that counts the number of times in which the signal processing module 141 attempts HDCP authentication. For example, the HDCP authentication determining module 143d determines that the HDCP authentication is failed, when the HDCP authentication counting module counts the specific number of times or more. Accordingly, the error diagnosing module 143 may detect an HDCP authentication error when the number of times (attempt number of HDCP authentication), in which the signal processing module 141 attempts the HDCP authentication, is the specific number of times or more.

The clock reception determining module 143e may determine whether the clock of the source device 200 is received to the display apparatus 100. According to an embodiment, the clock reception determining module 143e may include a clock counting module that counts the number of times in which the clock of the source device 200 is not received. For example, the clock reception determining module 143e may determine that the clock of the source device 200 is not received, when the clock counting module counts the specific number of times or more. Accordingly, the error diagnosing module 143 may detect a clock reception error when the number of times, in which the clock is not received, is the specific number of times or more.

According to an embodiment, the HDCP authentication 143d and the clock reception determining module 143e may generate information related to an error which occurs when the processor 140 (e.g., the signal processing module 141) fail to synchronize the clock of the display apparatus 100 and the clock of the source device 200. The information, for example, include information about the error related HDCP authentication failure, generated by the HDCP authentication 143d. Also, the information, include information about the error related the clock reception from the source device 200, generated by the clock reception determining module 143e.

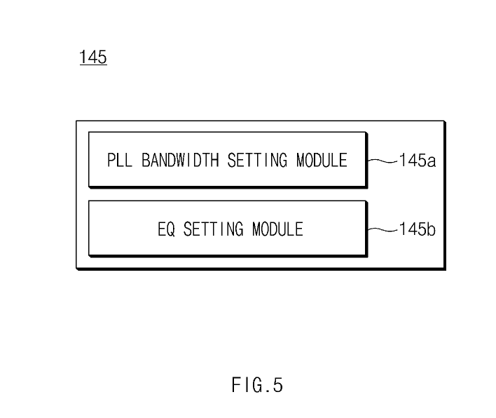

FIG. 5 is a block diagram illustrating the configuration of a calibration module, according to various embodiments of the present disclosure;

Referring to FIG. 5, the calibration module 145 may include a PLL bandwidth setting module 145a and an EQ setting module 145b. The calibration module 145 execute calibration for a received video signal based on the generated information related to the error, generated by the HDCP authentication 143d and the clock reception determining module 143e.

Referring to FIG. 5, the calibration module 145 may include a PLL bandwidth setting module 145a and an EQ setting module 145b.

The PLL bandwidth setting module 145a may adjusts the bandwidth of the PLL circuit of the signal processing module 141 to adjust the reception sensitivity of the video signal. The bandwidth of the PLL circuit may be, for example, a bandwidth of a low pass filter (LPF) of the PLL circuit. According to an embodiment, the PLL bandwidth setting module 145a may increase the bandwidth value of the PLL circuit to detect the phase difference between the clock of the display apparatus 100 and the clock of the source device 200. Accordingly, the signal processing module 141 may lock the phase of the clock of the display apparatus 100 by using the detected phase difference.

The EQ setting module 145b may adjust the EQ of the signal processing module 141 to adjust the reception sensitivity of the video signal. According to an embodiment, the EQ setting module 145b may change the EQ value to change the characteristic of the video signal, thereby detecting a clock included in the video signal. For example, the EQ setting module 145b may increase an EQ gain value to increase the intensity of the video signal, which is received, thereby detecting the clock included in the video signal. Accordingly, the signal processing module 141 may synchronize the detected clock of the source device 200 with the clock of the display apparatus 100.

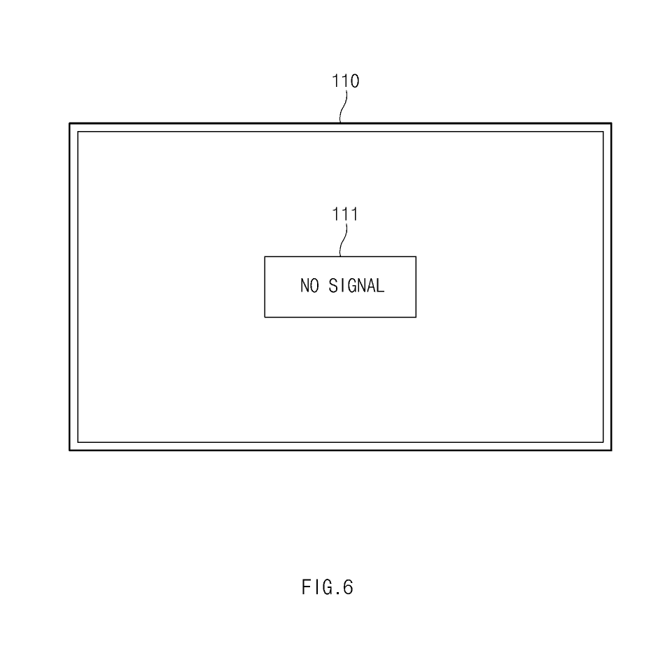

FIG. 6 illustrates a UI displayed on a display when the display apparatus fails to receive a video signal, according to various embodiments of the present disclosure.

Referring to FIG. 6, when the display apparatus 100 fails to receive the video signal, the processor 140 may display, on the display 110, a pop-up message 111 that the video signal is not received. Accordingly, a user may recognize that the video signal is not received.

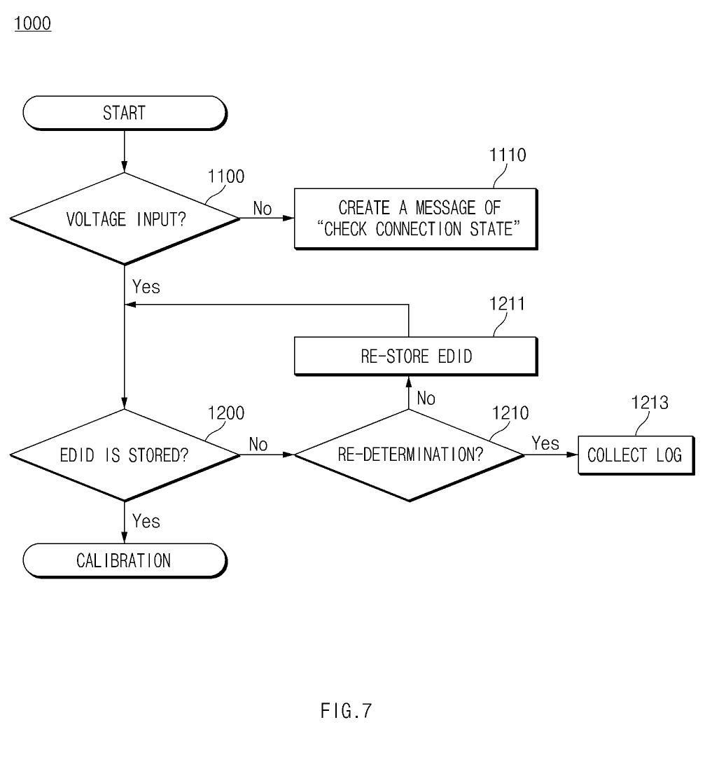

FIG. 7 is a flowchart illustrating the logic of a method of determining a connection standby state, according to various embodiments of the present disclosure.

Referring to FIG. 7, a method 1000 of determining a connection standby state may include operation 1100 of determining a voltage input and operation 1200 of determining EDID.

In operation 1100 of determining the voltage input, the connection state of the source device 200 may be determined. The HDMI voltage checking module 143a may check a connection state with the source device 200 by measuring a voltage having the specific size, which is inputted, when the source device 200 is connected through the HDMI interface.

According to an embodiment, when the HDMI voltage checking module 143a fails to measure the voltage having the specific size (No), the processor 140 may display a connection state message (e.g., check connection state) on the display 110 (1110).

According to an embodiment, when the HDMI voltage checking module 143a measures the voltage having the specific size (Yes), the processor 140 may perform operation 1200 of determining the EDID.

In operation 1200 of determining the EDID, it is determined whether the EDID is received by the source device 200. the EDID determining module 143b may determine whether the EDID is stored in the second memory 133 to determine whether the EDID is received by the source device 200.

According to an embodiment, when the EDID determining module 143b determines that the EDID is not stored in the second memory 133 (No), the EDID determining module 143b may determine whether the process of determining whether the EDID is stored in the second memory 133 is a re-determination process (1210). When the EDID determining module 143b first determines that the EDID is not stored in the second memory 133 (No), the processor 140 may re-store the EDID of the display apparatus 100 in the second memory 133 and then the EDID determining module 143b may re-determine whether the EDID is stored in the second memory 133 (1211). When the EDID determining module 143b re-determines that the EDID is not stored in the second memory 133 (Yes), the processor 140 may collect log information of the display apparatus 100 (1213). For example, the log information may include information on software and hardware of the display apparatus 100. Accordingly, a user may determine the defects of the display apparatus 100 by using the collected log information.

According to an embodiment, when the EDID determining module 143b determines that the EDID is stored in the second memory 133 (Yes), the processor 140 may perform a method 2000 of executing calibration.

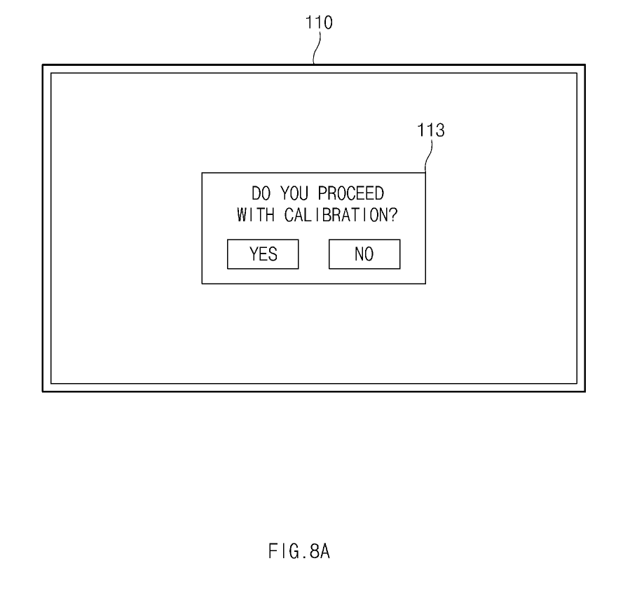

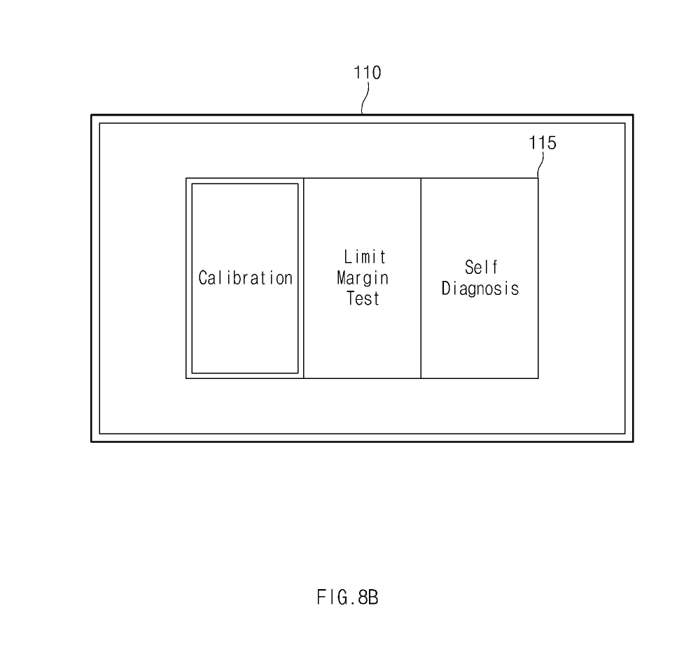

FIGS. 8A and 8B illustrate a UI displayed on the display to proceed with the calibration for the video signal, according to various embodiments of the present disclosure.

Referring to FIG. 8A, when performing the method 2000 of executing the calibration after performing the method 1000 of determining the connection standby state, the processor 140 may display a pop-up message 113 for receiving the input of a command of executing the calibration on the display 110. Accordingly, a user may input the command of executing the calibration into the pop-up message 113.

Referring to FIG. 8B, when the user inputs the command for performing the method 2000 of executing the calibration through the remote controller, the processor 140 may display a menu 115 for inputting the command of executing the calibration on the display 110. Accordingly, the user may input the command of executing the calibration into the menu 115.

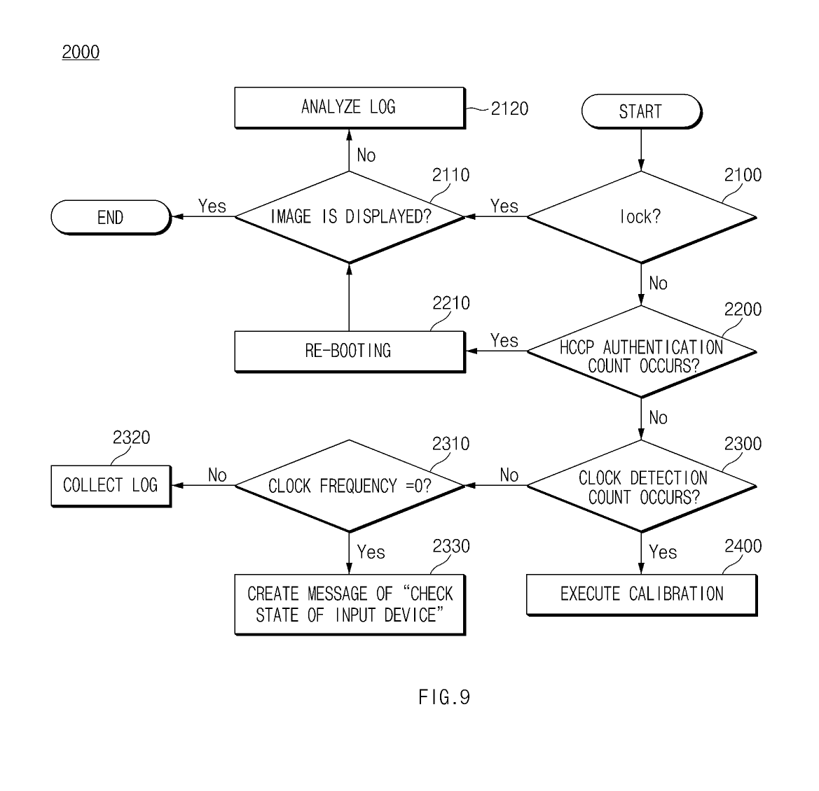

FIG. 9 is a flowchart illustrating the logic of a method of executing the calibration, according to various embodiments of the present disclosure.

Referring to FIG. 9, the method 2000 of executing the calibration may include operation 2100 of determining clock synchronization, operation 2200 of determining HDCP authentication, operation 2300 of determining clock reception, and operation 2400 of executing calibration for a video signal.

In operation 2100 of determining the clock synchronization, it is determined whether the clock of the display apparatus 100 is synchronized with the clock of the source device 200. For example, the clock synchronization determining module 143c may determine whether the clock of the display apparatus 100 is synchronized with the clock of the source device 200 by determining whether the clock of the display apparatus 100 is locked.

According to an embodiment, when the clock synchronization determining module 143c determines that the clock of the display apparatus 100 is locked (Yes), the processor 140 may determine whether an image is displayed on the display 110 (2110). When the processor 140 determines that the image is displayed on the display 110 (Yes), since the display apparatus 100 normally operates, the method 2000 of executing the calibration may be terminated without executing the calibration. When the processor 140 determines that the image is not displayed on the display 110 (No), since the display apparatus 100 does not normally operate, log information may be collected (2120).

According to an embodiment, when the clock synchronization determining module 143c determines that the clock of the display apparatus 100 is not locked (No), the processor 140 may perform operation 2200 of determining HDCP authentication (2200).

In operation 2200 of determining HDCP authentication, it is determined whether the HDCP authentication of the display apparatus 100 is succeeded by the signal processing module 141. For example, the HDCP authentication determining module 143d may include the HDCP authentication count module, and may determine whether the HDCP authentication is succeeded by determining the counted number of times (e.g., the attempt number of the HDCP authentication) by the HDCP authentication count module. The HDCP authentication determining module 143d may determine that the HDCP authentication is failed, when the HDCP authentication count module counts the specific number of times or more (e.g., one time or more).

According to an embodiment, when the HDCP authentication count modules counts the number of times of the attempt of the HDCP authentication (Yes), the display apparatus 100 may be re-booted (2210) to reattempt the HDCP authentication. When the display apparatus 100 is re-booted, it is determined whether the image is displayed on the display 110 (2210). When it is determined that the image is displayed on the display 110 (Yes), since the display apparatus 100 normally operates, the method 2000 of executing the calibration may be terminated without executing the calibration. When it is determined that the image is not displayed on the display 110 (No), since the display apparatus 100 does not normally operate, log information may be collected (2120).

According to an embodiment, when the HDCP authentication count module fails to count the number of times of HDCP authentication (No), the processor 140 may perform operation 2300 of determining clock reception.

In operation 2300 of determining clock reception, it is determined whether the display apparatus 100 receives the clock of the source device 200. For example, the clock reception determining module 143e may include a clock count module and may determine whether the clock of the source device 200 is received by determining the counted number of times (e.g., the number of times in which the clock is not received) of the clock count module. For example, the clock reception determining module 143e may determine that the clock of the source device 200 is not received, when the clock count module counts the specific number of times or more (e.g., one time or more).

According to an embodiment, when the clock count module fails to count the number of times in which the clock of the source device 200 is not received (No), the clock frequency of the source device 200 may be checked (2310). When it is determined that the clock frequency of the source device 200 is zero (Yes), the processor 140 may display a message for checking the state of an input device (check the state of an input device state) on the display 110. When it is determined that the clock frequency of the source device 200 is not zero (No), since the display apparatus 100 does not normally operate, log analysis may be performed (2320).

According to an embodiment, when the clock count module counts the number of times in which the clock of the source device 200 is not received (Yes), the processor 140 may execute the calibration for the video signal (2400).

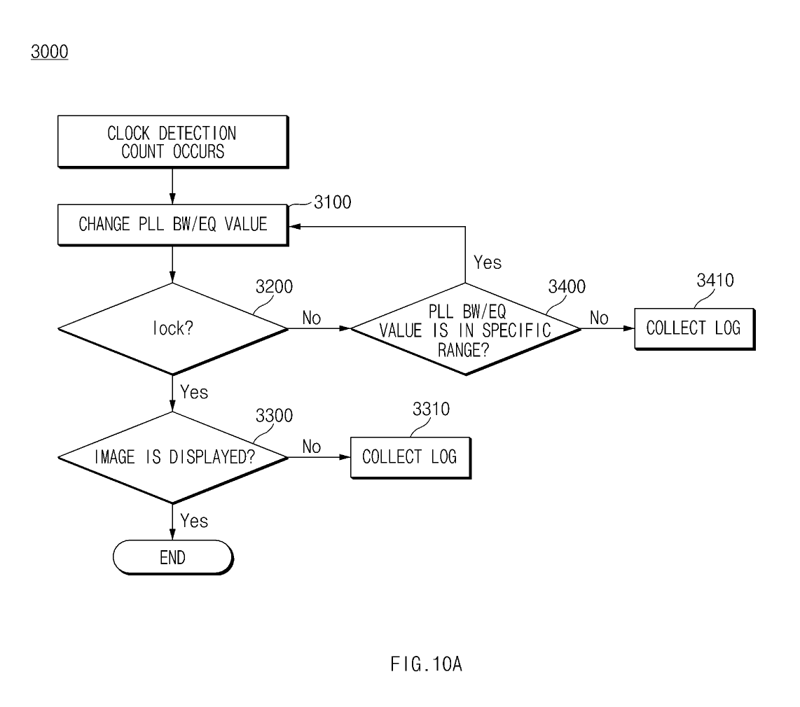

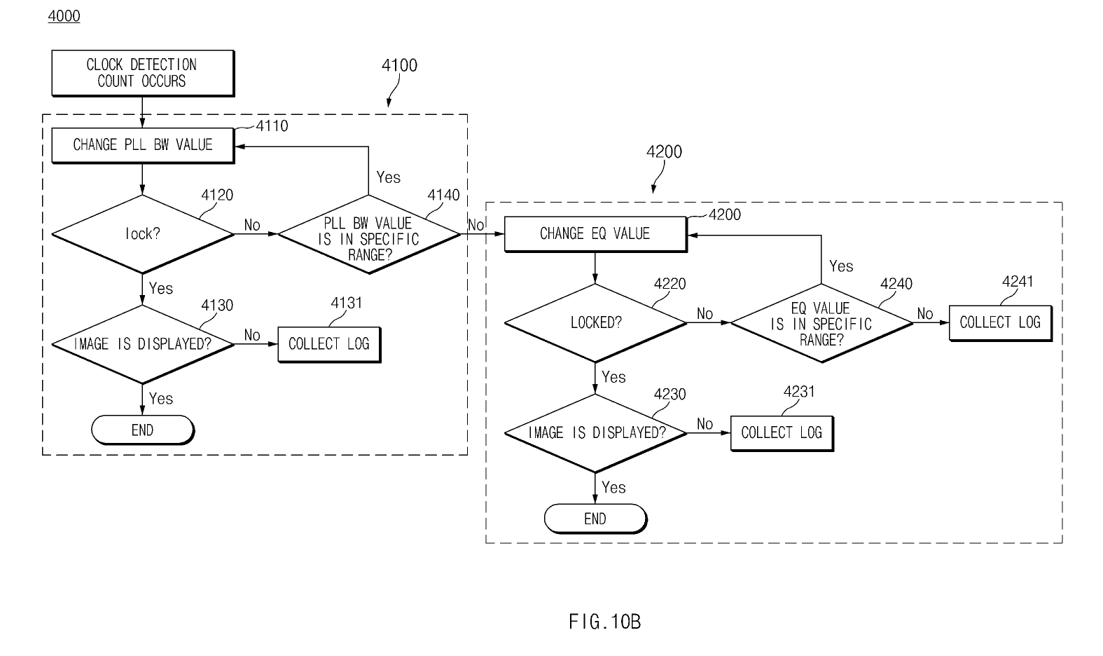

FIG. 10A is a flowchart illustrating the logic of a method of adjusting the bandwidth value of the PLL circuit or the EQ value, according to an embodiment of the present disclosure.

Referring to FIG. 10A, a method 3000 of performing calibration for a video signal includes operation 3100 of changing the bandwidth value of the PLL circuit or the EQ value, operation 3200 of determining clock synchronization, operation 3300 of determining an image on the display, and operation 3400 of determining whether the bandwidth value of the PLL circuit or the EQ value is in a specific range.

In operation 3100 of changing the bandwidth value of the PLL circuit or the EQ value, the bandwidth value of the PLL circuit or the EQ value may be changed when the clock of the source device 200 is not received in operation 2300 of determining clock reception. For example, the calibration module 145 may increase the bandwidth value of the PLL circuit or the EQ value of the signal processing module 141 by a specific value. Alternatively, the calibration module 145 may change the bandwidth value of the PLL circuit or the EQ value of the signal processing module 141 to a specific index value.

In operation 3200 of determining clock synchronization, it is determined whether the clock of the display apparatus 100 is synchronized with the clock of the source device 200 as the bandwidth value of the PLL circuit or the EQ value is changed. For example, the clock synchronization determining module 143c may determine whether the clock of the display apparatus 100 is synchronized, by determining whether the clock of the display apparatus 100 is locked.

According to an embodiment, when the clock synchronization determining module 143c determines that the clock of the display apparatus 100 is locked (Yes), the processor 140 may determine whether the image is displayed on the display 110 (3300). When the processor 140 determines that the image is displayed on the display 110 (Yes), since the display apparatus 100 normally operates, the method 3000 of executing the calibration may be terminated. When the processor 140 determines that the image is not displayed on the display 110 (No), since the display apparatus 100 does not normally operate, log information may be collected (3310).

According to an embodiment, when the clock synchronization determining module 143c determines that the clock of the display apparatus 100 is not locked (No), the calibration module 145 may perform operation 3400 of determining whether the bandwidth value of the PLL circuit or the EQ value is in the specific range. When it is determined that the bandwidth value of the PLL circuit or the EQ value is in the specific range (Yes), the calibration module 145 may perform operation 3100 of changing the bandwidth value of the PLL circuit or the EQ value again. When it is determined that the bandwidth value of the PLL circuit or the EQ value is not in the specific range (No), since the display apparatus 100 does not normally operate, log information may be collected (3410). The specific range of the bandwidth value of the PLL circuit or the EQ value may be, for example, a range in which the display apparatus 100 receives information, which is transmitted from the source device 200, without distortion.

According to another embodiment, in operation 3100 of changing the bandwidth value of the PLL circuit or the EQ value, when the bandwidth value of the PLL circuit or the EQ value is changed to the specific index value, the calibration module 145 may perform an operation of determining whether the change of all the index values is made when determining whether the bandwidth value of the PLL circuit or the EQ value needs to be re-changed. The index value may be, for example, a value in the range in which the display apparatus 100 receives information, which is transmitted from the source device 200, without distortion.

FIG. 10B is a flowchart illustrating the logic of a method of sequentially adjusting a bandwidth value of a PLL circuit and an EQ value, according to an embodiment of the present disclosure.

Referring to FIG. 10B, method 4000 of executing calibration for the video signal may include operation 4100 of changing the bandwidth of the PLL circuit and operation 4200 of changing the EQ value. Method 4000 of executing the calibration for the video signal may be performed by subsequently performing operation 4100 of changing the bandwidth of the PLL circuit and operation 4200 of changing the EQ value.

Operation 4100 of changing the bandwidth of the PLL circuit may include operation 4110 of changing the bandwidth value of the PLL circuit, operation 4120 of determining clock synchronization, operation 4130 of determining the image on the display, and operation 4140 of determining whether the bandwidth value of the PLL circuit is in the specific range.

According to an embodiment, operation 4110 of changing the bandwidth value of the PLL circuit, operation 4120 of determining the clock synchronization, and operation 4130 of determining the image on the display may be similar to operation 3100 of changing the bandwidth value of the PLL circuit or the EQ value, operation 3200 of determining the clock synchronization, and operation 3300 of determining the image on the display as illustrated in FIG. 10A. Although operation 4140 of determining whether the bandwidth value of the PLL circuit is in the specific range is similar to operation 3400 of determining whether the bandwidth value of the PLL circuit or the EQ value is in the specific range in FIG. 10A, the calibration module 145 may perform operation 4200 of changing the EQ, when the bandwidth value of the PLL circuit is not in the specific range (No), which is different from that of FIG. 10A.

For example, the PLL bandwidth setting module 145a may change the bandwidth to a value within the set range.

Operation 4200 of changing the EQ may include operation 4210 of changing the EQ value, operation 4220 of determining clock synchronization, operation 4230 of determining the image on the display, and operation 4240 of determining whether the EQ value is in the specific range.

According to an embodiment, operation 4210 of changing the EQ value, operation 4220 of determining the clock synchronization, operation 4230 of determining the image on the display, and operation 4140 of determining whether the EQ value is within the specific range may be similar to operation 3100 of changing the bandwidth value of the PLL circuit or the EQ value, operation 3200 of determining clock synchronization, operation 3300 of determining the image on the display, and operation 3400 of determining whether the bandwidth value of the PLL circuit or the EQ value is in the specific range as illustrated in FIG. 10A. Operation 4210 of changing the EQ value is similar to operation 3100 of changing the bandwidth value of the PLL circuit or the EQ value except that operation 4210 of changing the EQ value is performed in the case that the bandwidth value of the PLL circuit is not in the allowed specific range.

According to an embodiment, method 4000 of executing the calibration for the video signal may be performed by first performing any one of operation 4100 of changing the bandwidth of the PLL circuit and operation 4200 of changing the EQ value. For example, in method 4000 of executing the calibration, the bandwidth value of the PLL circuit having a narrower change range may be first changed.

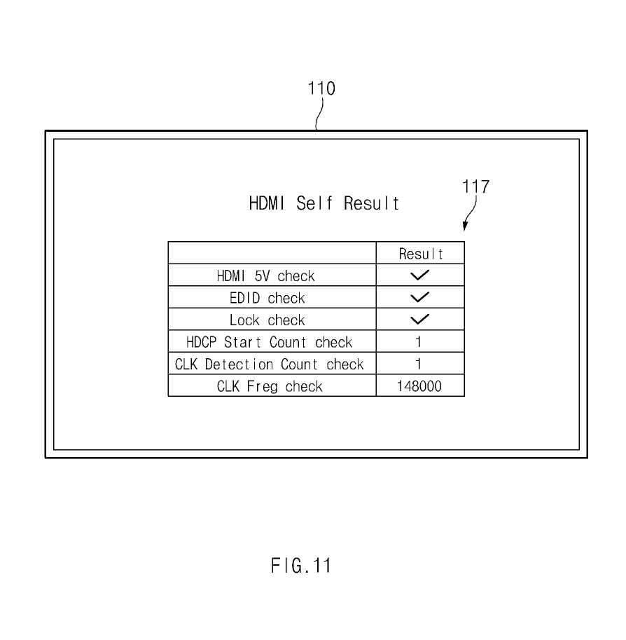

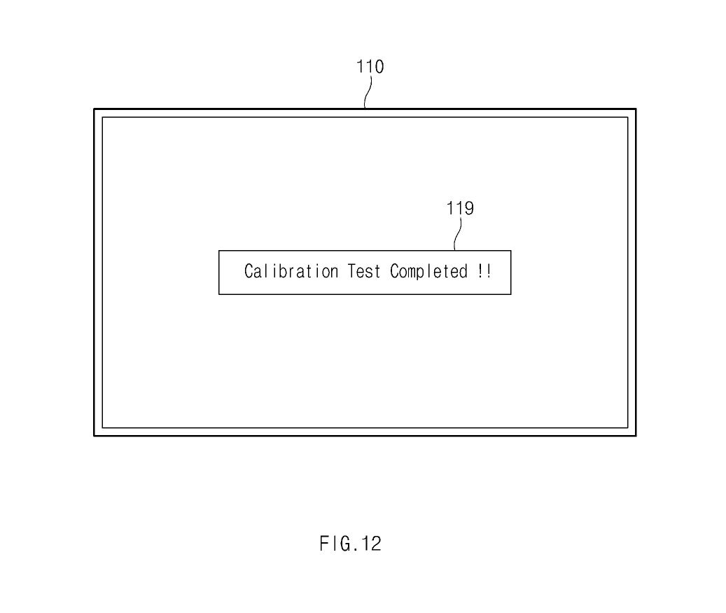

FIGS. 11 and 12 illustrate the UI displayed on the display after calibration is performed, according to various embodiments of the present disclosure.

Referring to FIG. 11, when the display apparatus 100 performs the method 1000 of determining the connection standby state and the method 2000 of executing the calibration, the processor 140 may display a message 117, which is to represent the execution result, on the display 110. Accordingly, a user may recognize causes why the display apparatus 100 fails to receive the video signal.

Referring to FIG. 12, when performing methods 3000 and 4000 of executing the calibration for the video signal, the processor 140 may display a message 119, which is to represent the completion of execution, on the display 110. Accordingly, the user may recognize that the calibration in the display apparatus 100 is completed.

According to the display apparatus 100 and the method 2000 of executing the calibration in the display apparatus 100, when the video signal is not received, the clock of the display apparatus 100 may be checked, and, when the clock of the display apparatus 100 is not synchronized, the calibration of changing the bandwidth of the PLL circuit and the EQ may be executed, such that the video signal is received.

In addition, before performing methods 3000 and 4000 of executing the calibration for the video signal, the connection state of the HDMI cable, the presence of the EDID, and the authentication state of the HDCP may be determined such that appropriate measures are taken to receive the HDMI signal.

The term “module” used in this disclosure may represent, for example, a unit including one or the combination of at least two of hardware, software, or firmware. For example, the term “module” may be interchangeably used with the terms “unit”, “logic”, “logical block”, “component”, “circuit”, or the like. The term “module” may be the minimum unit of components, which are integrally configured, or a part thereof, or may be the minimum unit for performing one or more functions or a part thereof. The module may be mechanically or electronically implemented. For example, the module may include application-specific integrated circuit (ASIC) chips, field-programmable gate arrays (FPGAs), or programmable logical devices which perform certain operations, are known to perform the operations, or are to be developed in the future.

According to various embodiments, at least a part of an apparatus (e.g., modules or functions thereof) or a method (e.g., operations) may be implemented by instructions stored computer-readable storage media in the form of a program module. When the instructions are executed by a processor, at least one processor may perform a function corresponding to the instruction. The computer-readable storage media may include, for example, memories.

The computer-readable storage media may include hard discs, floppy discs, magnetic media (e.g., magnetic tapes), optical recording media (e.g., compact disk Read Only Memories (CD-ROMs), digital versatile disks (DVDs), magneto-optical media (e.g., floptical disks), or hardware devices (e.g., ROMs, RAMs, or flash memories). The program instructions may include machine language codes generated by a compiler or high level language codes that may be executed by a computer using an interpreter. The hardware devices may be configured to operate in the form of at least one software module to execute operations according to various embodiments, and vice versa.

According to various embodiments, a module or a program module may include at least one of the above elements, may include the above elements, some of which are omitted, or may include additional elements. According to various embodiments, operations performed by a module, a program module, or other elements may be executed sequentially, in parallel, repeatedly, or in a heuristic manner. In addition, some operations may be executed in different sequences or may be omitted. Alternatively, other operations may be added.

According to the display apparatus and the method of executing the calibration in the display apparatus of the present disclosure, when the HDMI signal is not received, the clock of the display apparatus is checked. When the clock of the display apparatus is not synchronized, the calibration of changing the bandwidth of the PLL and the EQ is executed, thereby receiving the HDMI signal.

In addition, before executing the calibration, the connection state of the HDMI cable, the presence of the EDID, and the authentication state of the HDCP may be determined such that appropriate measures are taken to receive the HDMI signal.

Although the embodiments disclosed in this disclosure have been described for the illustrative purpose, it will be understood by those skilled in the art that this disclosure is not limited thereto, but various changes and modifications of the embodiments may be made without departing from the spirit and scope of this disclosure as defined by the appended claims and their equivalents.

What is claimed is:

1. A display apparatus comprising:
a communication interface connected with a source device to receive a video signal from the source device;
a display configured to display the video signal received from the source device; and
a processor configured to establish a connection with the source device to receive the video signal through the communication interface,
wherein the processor is configured to:
synchronize a clock of the display apparatus with a clock of the source device to establish the connection; and
execute calibration for the received video signal, when detecting an error occurring as the clock of the display apparatus fails to be synchronized.

2. The display apparatus of claim 1, wherein the processor is further configured to:
execute the calibration for the video signal, when detecting an error occurring as the clock of the source device fails to be received.

3. The display apparatus of claim 2, wherein the processor is further configured to:
count a number of times in which the clock of the source device fails to be received; and
determine that the error occurs, when the counted number of times is equal to or greater than a specific value.

4. The display apparatus of claim 1, wherein the processor is configured to:
execute the calibration for the video signal when detecting an error occurring as HDCP authentication failure.

5. The display apparatus of claim 4, wherein the processor is configured to:
count a number of times in which the HDCP authentication is started; and
determine the error occurring when an HDCP authentication counting module counts a specific number of times or more.

6. The display apparatus of claim 1, wherein the processor is configured to:
synchronize the clock of the display apparatus by changing at least one of a bandwidth value of a phase locked loop (PLL) circuit and an equalizer (EQ) value.

7. The display apparatus of claim 6, wherein the processor is configured to:
change the bandwidth value of the PLL circuit to a value within a first range specified to receive the video signal without distortion when the bandwidth value of the PLL circuit is changed; and
change the EQ value to a value within a second range specified to receive the video signal without distortion when the EQ value is changed.

8. The display apparatus of claim 6, wherein the processor is configured to:
synchronize the clock of the display apparatus by changing the bandwidth value of the PLL circuit; and
synchronize the clock of the display apparatus by changing the EQ value when the clock of the display apparatus fails to be synchronized even though the bandwidth value of the PLL circuit is changed.

9. The display apparatus of claim 1, wherein the processor is configured to:
measure, when the source device is connected through the communication interface, an input voltage having a specific size to check the connection, and
execute the calibration when the voltage fails to be measured.

10. The display apparatus of claim 1, further comprising:
a memory configured to store extended display identification data (EDID) of the display apparatus such that the EDID is transmitted to the source device,
wherein the processor includes a memory configured to store the EDID of the display apparatus, and
wherein the processor is configured to:
determine whether the EDID of the display apparatus is stored in the memory; and
execute the calibration for the video signal when the EDID of the display apparatus fails to be stored in the memory.

11. A method of executing calibration in a display apparatus, the method comprising:
determining whether a clock of the display apparatus is synchronized with a clock of a source device; and
executing calibration for a video signal in the display apparatus when the clock of the display apparatus fails to synchronize with the clock of the source driver.

12. The method of claim 11, further comprising:
determining whether the display apparatus receives the clock of the source device,
wherein the executing of the calibration for the video signal further includes:
executing the calibration for the video signal when determined that the display apparatus fails to receive the clock of the source device.

13. The method of claim 11, further comprising:
determining whether high-bandwidth digital content protection (HDCP) authentication of the display apparatus is succeeded,
wherein the executing of the calibration for the video signal includes:
executing the calibration for the video signal when the HDCP authentication of the display apparatus is failed.

14. The method of claim 11, wherein the executing of the calibration for the video signal includes:
changing at least one of a bandwidth value of a PLL circuit and an EQ value; and
determining whether the clock of the display apparatus is synchronized with the clock of the source device as the at least one of the bandwidth value of the PLL circuit and the EQ value is changed.

15. The method of claim 14, wherein the executing of the calibration for the video signal further includes:
determining whether both of the bandwidth value of the PLL circuit and the EQ value are changed to specific values when the clock of the display apparatus fails to be synchronized with the clock of the source device even though the bandwidth value of the PLL circuit and the EQ value are changed

16. The method of claim 11, wherein the executing of the calibration for the video signal includes:
changing a bandwidth value of a PLL circuit;
determining whether the clock of the display apparatus is synchronized with the clock of the source device as the bandwidth value of the PLL circuit is changed;
changing an EQ value when the clock of the display apparatus fails to be synchronized with the clock of the source device even though the bandwidth value of the PLL circuit is changed; and
determining whether the clock of the display apparatus is synchronized with the clock of the source device as the EQ value is changed.

17. The method of claim 11, further comprising:
measuring an input voltage having a specific size when the source device is connected through a communication interface,
wherein the executing of the calibration for the video signal includes:
executing the calibration for the video signal when the voltage having the specific size fails to be measured.

18. The method of claim 11, further comprising:
determining whether EDID of the display apparatus is stored in a memory of a processor,
wherein the executing of the calibration for the video signal includes:
executing the calibration for the video signal when the EDID of the display apparatus fails to be stored in the memory of the processor.

19. A computer-readable recording medium having a program of executing a method comprising:
determining whether a clock of a display apparatus is synchronized with a clock of a source device; and
executing calibration for a video signal in the display apparatus when the clock of the display apparatus fails to be synchronized with the clock of the source driver.

20. The computer-readable recording medium of claim 19, wherein the method further includes:
determining whether the display apparatus receives the clock of the source device, and
wherein the executing of the calibration for the video signal includes:
executing the calibration for the video signal when the display apparatus fails to receive the clock of the source driver.
